(19) United States
(12) Patent Application Publication
(10) Pub. No.: US 2019/0247912 A1
(43) Pub. Date: Aug. 15, 2019

(54) Heating Coil Production System

(71) Applicants: Jamar Rambally, Jamaica, NY (US); Gregory Geffrard, Jamaica, NY (US)

(72) Inventors: Jamar Rambally, Jamaica, NY (US); Gregory Geffrard, Jamaica, NY (US)

(21) Appl. No.: 15/897,873

(22) Filed: Feb. 15, 2018

(51) Int. Cl. B21F 3/08; A24F 47/00; B65H 54/74; B65H 55/00

(52) U.S. Cl. CPC B21F 3/08; A24F 47/008; H05B 3/22; B65H 55/00; B65H 54/74

(57) ABSTRACT

A heating coil production system for producing heating coils for electronic vaporizers includes a conductor that has a first end and a second end. An anchor is provided and the anchor is selectively positioned on a support surface. The second end of the conductor is removably coupled to the anchor. A rotation unit is provided and the rotation unit is selectively positioned on the support surface and the rotation unit is selectively turned on and off. The first end of the conductor is selectively coupled to the rotation unit and the rotation unit twists the conductor into a coil when the rotation unit is turned on. The resulting coil is positioned in an electronic smoking device for a heating element.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to coil production devices and more particularly pertains to a new coil production device for producing heating coils for electronic vaporizers.

### BRIEF SUMMARY OF THE INVENTION

An embodiment of the disclosure meets the needs presented above by generally comprising a conductor that has a first end and a second end. An anchor is provided and the anchor is selectively positioned on a support surface. The second end of the conductor is removably coupled to the anchor. A rotation unit is provided and the rotation unit is selectively positioned on the support surface and the rotation unit is selectively turned on and off. The first end of the conductor is selectively coupled to the rotation unit and the rotation unit twists the conductor into a coil when the rotation unit is turned on. The resulting coil is positioned in an electronic smoking device for a heating element.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a rotation unit of a heating coil production system according to an embodiment of the disclosure.

FIG. 2 is a front view of a rotation unit of an embodiment of the disclosure.

FIG. 3 is a back phantom view of a rotation unit of an embodiment of the disclosure.

FIG. 4 is a right side phantom view of a rotation unit of an embodiment of the disclosure.

FIG. 5 is a bottom view of an embodiment of the disclosure.

FIG. 6 is a perspective view of an embodiment of the disclosure.

### DETAILED DESCRIPTION OF THE INVENTION

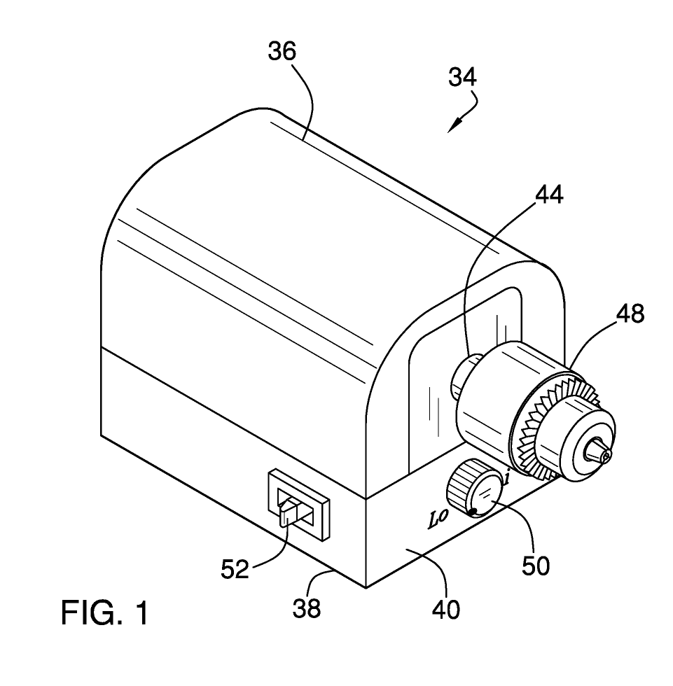

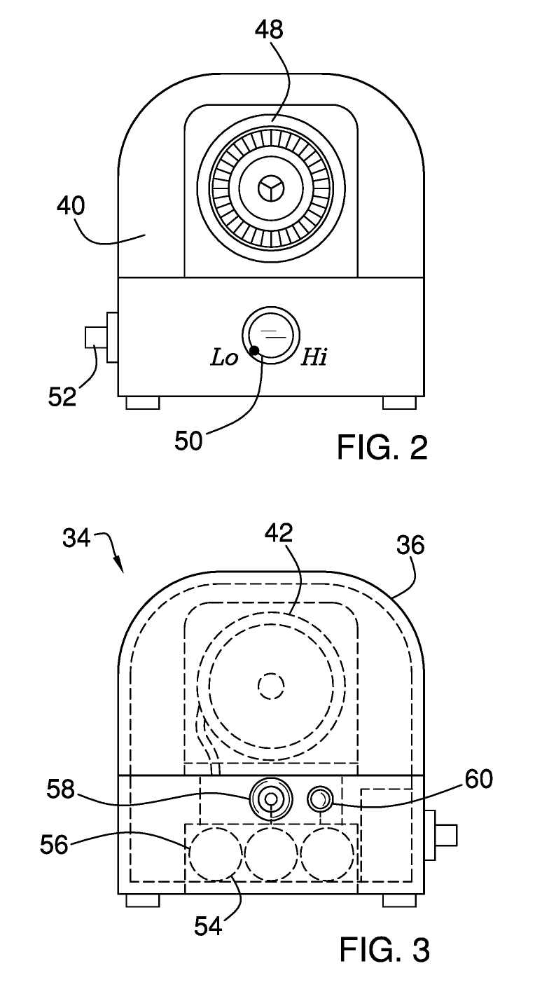

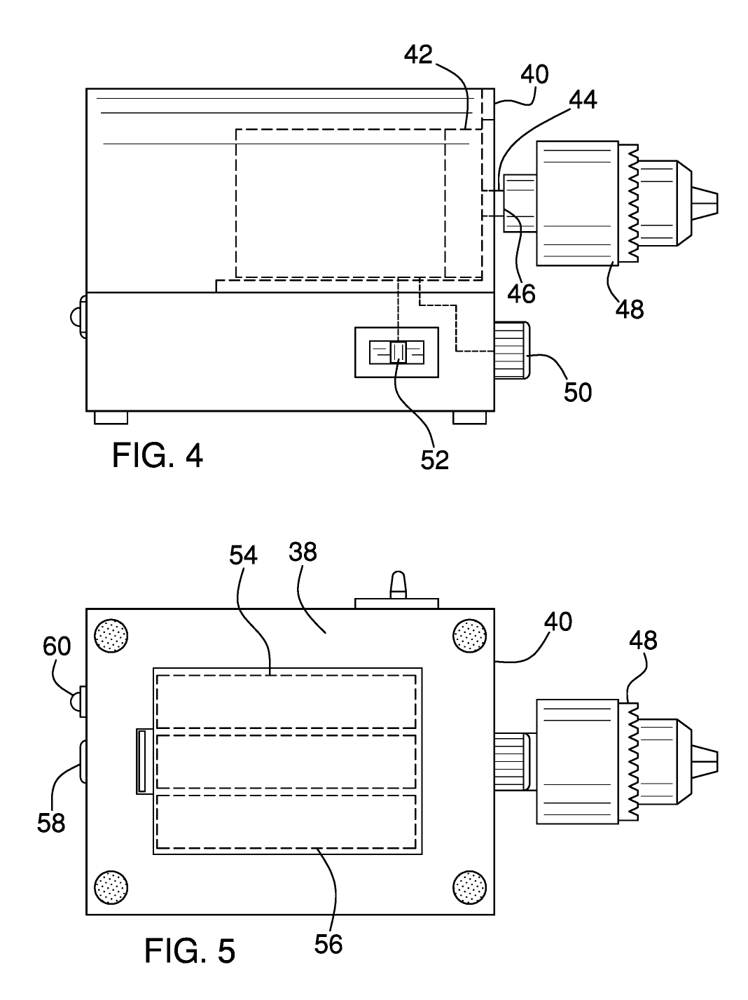

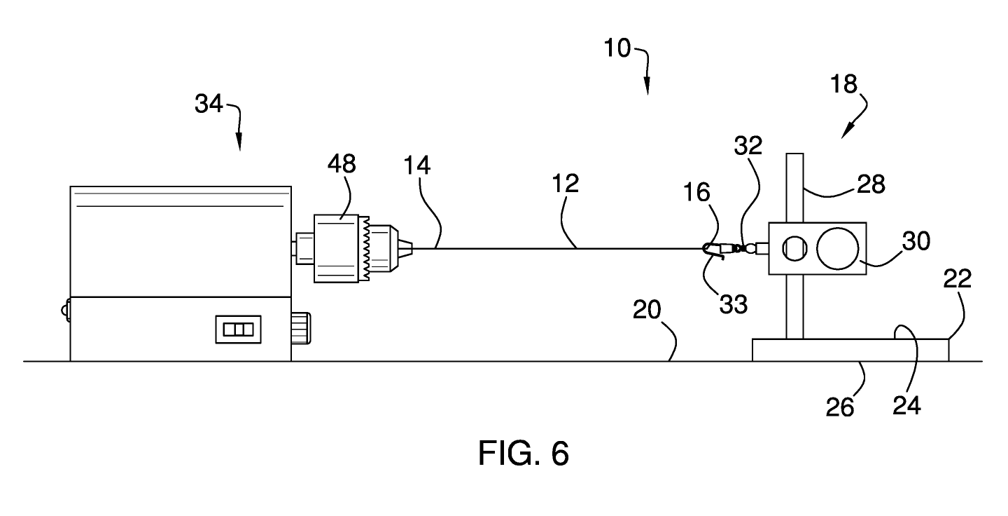

With reference now to the drawings, and in particular to FIGS. 1 through 6 thereof, a new coil production device embodying the principles and concepts of an embodiment of the disclosure and generally designated by the reference numeral 10 will be described.

As best illustrated in FIGS. 1 through 6, the heating coil production system 10 generally comprises a conductor 12 that has a first end 14 and a second end 16. The conductor 12 may be a conductor 12 used to form heating coils for electronic vaporizers or the like. The electronic vaporizer may be an electronic vaporizer for smoking tobacco products and the like. An anchor 18 is provided and the anchor 18 is selectively positioned on a support surface 20 such as a table top or the like. The second end 16 of the conductor 12 is removably coupled to the anchor 18.

The anchor 18 comprises a base 22 that has a first surface 24 and a second surface 26 and the second surface 26 abuts the support surface 20. A post 28 extends upwardly from the first surface 24 and a slide 30 is slidably positioned on the post 28. The slide 30 is positioned at a selected point along the post 28 and the slide 30 frictionally engages to post 28 to stay at the selected point. A swivel 32 is rotatably coupled to the slide 30 and the swivel 32 includes a hook 33. The second end 16 of the conductor 12 is releasably coupled to the hook 33 having the conductor 12 being horizontally oriented. Moreover, the conductor 12 is selectively rotated about an axis extending through the first end 14 and the second and when the conductor 12 is coupled to the swivel 32.

A rotation unit 34 is provided and the rotation unit 34 is selectively positioned on the support surface 20. The rotation unit 34 is selectively turned on and off and the first end 14 of the conductor 12 is selectively coupled to the rotation unit 34. The rotation unit 34 twists the conductor 12 into a coil when the rotation unit 34 is turned on. In this way the coil is formed for use as a heating element in the electronic smoking device.

The rotation unit 34 comprises a housing 36 that has a bottom wall 38 and a front wall 40 and the bottom wall 38 is positioned on the support surface 20. The housing 36 is spaced from the anchor 18 having the front wall 40 being directed toward the anchor 18. A motor 42 is positioned in the housing 36 and the motor 42 may be an electric motor 42 or the like. A shaft 44 is coupled to the motor 42 such that the motor 42 rotates the shaft 44 when the motor 42 is turned on. The shaft 44 extends through the front wall 40 of the housing 36 and the shaft 44 has a distal end 46 with respect to the front wall 40. The housing 36 may have a length, a width and a height each ranging between approximately 10.0 cm and 15.0 cm.

A chuck 48 is coupled to the distal end 46 of the shaft 44 and the shaft 44 rotates the chuck 48 when the motor 42 is turned on. The chuck 48 selectively engages the first end 14 of the conductor 12 thereby coupling the conductor 12 to the chuck 48. The chuck 48 twists the conductor 12 about the axis extending through the first end 14 and the second end 16 of the conductor 12 when the motor 42 is turned on. Additionally, the chuck 48 may be a drill chuck 48 of any conventional design.

A speed control 50 is movably coupled to the housing 36 and the speed control 50 is selectively manipulated. The speed control 50 is electrically coupled the motor 42 such that the speed control 50 adjusts a speed of the motor 42 between a minimum speed and a maximum speed. A power switch 52 is movably coupled to the housing 36 and the power switch 52 is selecively manipulated. The power switch 52 is electrically coupled the motor 42 to turn the motor 42 on and off.

A power supply 54 is removably coupled to the housing 36 and the power supply 54 is electrically coupled to the motor 42. The power supply 54 comprises at least one battery 56 that is removably positioned within the housing 36. The at least one battery 56 is electrically coupled to the motor 42. Additionally, the at least one battery 56 may be a rechargeable battery that is common to electronic vaporizers. In this way the at least one battery 56 may be replaceable with a battery from the electronic vaporizer. A battery cover 57 may be removably coupled to the housing 36 and the power supply 54 may be positioned beneath the battery cover 57.

A charge port 58 is coupled to the housing 36 and the charge port 58 is electrically coupled to the at least one battery 56. The charge port 58 is selectively and electrically coupled to a power source for charging the at least one battery 56. The power source may be a battery 56 charger or the like. A light emitter 60 is coupled to the housing 36 to emit light outwardly therefrom. The light emitter 60 is electrically coupled the at least one battery 56 and the light emitter 60 emits an intensity of light corresponding to a level of charge of the at least one battery 56. The light emitter 60 may be an LED or the like.

In use, the anchor 18 is positioned on the support surface 20 and the rotation unit 34 is spaced from the anchor 18. The conductor 12 is coupled between the swivel 32 and the chuck 48 on the rotation unit 34. The power switch 52 is manipulated to turn the motor 42 on to twist the conductor 12 into the coil. The power switch 52 is manipulated to turn the motor 42 off when the coil is produced and the coil is removed from the anchor 18 and the chuck 48. The coil is cut to a selected length for use as a heating coil in the electronic vaporizer.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A heating coil production system for selectively twisting a conductor into a coil, said system comprising:
a conductor having a first end and a second end;
an anchor being configured to be positioned on a support surface, said second end of said conductor being removably coupled to said anchor; and
a rotation unit being configured to be positioned on the support surface, said rotation unit being selectively turned on and off, said first end of said conductor being selectively coupled to said rotation unit, said rotation unit twisting said conductor into a coil when said rotation unit is turned on wherein said coil is configured to be positioned in an electronic smoking device for a heating element.

2. The system according to claim 1, wherein said anchor comprises a base having a first surface and a second surface, said second surface being configured to abut the support surface.

3. The system according to claim 2, further comprising:
a post extending upwardly from said first surface; and
a slide being slidably positioned on said post, said slide being positioned at a selected point along said post.

4. The system according to claim 3, further comprising a swivel being rotatably coupled to said slide, said swivel including a hook, said second end of said conductor being releasably coupled to said hook having said conductor being horizontally oriented, said conductor being selectively rotated about an axis extending through said first end and said second and when said conductor is coupled to said swivel.

5. The system according to claim 1, wherein said rotation unit comprises a housing having a bottom wall and a front wall, said bottom wall being configured to be positioned on the support surface, said housing being spaced from said anchor having said front wall being directed toward said anchor.

6. The system according to claim 5, further comprising:
a motor being positioned in said housing; and
a shaft being coupled to said motor such that said motor rotates said shaft when said motor is turned on, said shaft extending through said front wall of said housing, said shaft having a distal end with respect to said front wall.

7. The system according to claim 6, further comprising a chuck being coupled to said distal end of said shaft such that said shaft rotates said chuck when said motor is turned on, said chuck selectively engaging said first end of said conductor to couple said conductor to said chuck, said chuck twisting said conductor about an axis extending through said first end and said second end of said conductor when said motor is turned on.

8. The system according to claim 7, further comprising a speed control being movably coupled to said housing wherein said speed control is configured to be manipulated, said speed control being electrically coupled said motor such that said speed control adjusts a speed of said motor between a minimum speed and a maximum speed.

9. The system according to claim 7, further comprising a power switch being movably coupled to said housing wherein said power switch is configured to be manipulated, said power switch being electrically coupled said motor, said power switch turning said motor on and off.

10. The system according to claim 6, further comprising a power supply being removably coupled to said housing, said power supply being electrically coupled to said motor.

11. The system according to claim 10, wherein said power supply comprises at least one battery being removably positioned within said housing, said at least one battery being electrically coupled to said motor.

12. The system according to claim 11, further comprising a charge port being coupled to said housing, said charge port being electrically coupled to said at least one battery, said charge port being configured to be electrically coupled to a power source for charging said at least one battery.

13. The system according to claim 12, further comprising a light emitter being coupled to said housing wherein said light emitter is configured to emit light outwardly therefrom, said light emitter being electrically coupled said at least one battery, said light emitter emitting an intensity of light corresponding to a level of charge of said at least one battery.

14. A heating coil production system for selectively twisting a conductor into a coil, said system comprising:
a conductor having a first end and a second end;
an anchor being configured to be positioned on a support surface, said second end of said conductor being removably coupled to said anchor, said anchor comprising:
a base having a first surface and a second surface, said second surface being configured to abut the support surface,
a post extending upwardly from said first surface,
a slide being slidably positioned on said post, said slide being positioned at a selected point along said post, and
a swivel being rotatably coupled to said slide, said swivel including a hook, said second end of said conductor being releasably coupled to said hook having said conductor being horizontally oriented, said conductor being selectively rotated about an axis extending through said first end and said second and when said conductor is coupled to said swivel; and
a rotation unit being configured to be positioned on the support surface, said rotation unit being selectively turned on and off, said first end of said conductor being selectively coupled to said rotation unit, said rotation unit twisting said conductor into a coil when said rotation unit is turned on wherein said coil is configured to be positioned in an electronic smoking device for a heating element, said rotation unit comprising:
a housing having a bottom wall and a front wall, said bottom wall being configured to be positioned on the support surface, said housing being spaced from said anchor having said front wall being directed toward said anchor,
a motor being positioned in said housing,
a shaft being coupled to said motor such that said motor rotates said shaft when said motor is turned on, said shaft extending through said front wall of said housing, said shaft having a distal end with respect to said front wall,
a chuck being coupled to said distal end of said shaft such that said shaft rotates said chuck when said motor is turned on, said chuck selectively engaging said first end of said conductor to couple said conductor to said chuck, said chuck twisting said conductor about said axis extending through said first end and said second end of said conductor when said motor is turned on,
a speed control being movably coupled to said housing wherein said speed control is configured to be manipulated, said speed control being electrically coupled said motor such that said speed control adjusts a speed of said motor between a minimum speed and a maximum speed,
a power switch being movably coupled to said housing wherein said power switch is configured to be manipulated, said power switch being electrically coupled said motor, said power switch turning said motor on and off, and
a power supply being removably coupled to said housing, said power supply being electrically coupled to said motor, said power supply comprising:
at least one battery being removably positioned within said housing, said at least one battery being electrically coupled to said motor,
a charge port being coupled to said housing, said charge port being electrically coupled to said at least one battery, said charge port being configured to be electrically coupled to a power source for charging said at least one battery, and
a light emitter being coupled to said housing wherein said light emitter is configured to emit light outwardly therefrom, said light emitter being electrically coupled said at least one battery, said light emitter emitting an intensity of light corresponding to a level of charge of said at least one battery.
